(19) United States
(12) Patent Application Publication
(10) Pub. No.: US 2004/0265643 A1
(43) Pub. Date: Dec. 30, 2004

(54) Magnetic recording medium and magnetic recording and reproducing methods

(75) Inventor: Kiyomi Ejiri, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/872,520

(22) Filed: Jun. 22, 2004

(30) Foreign Application Priority Data
Jun. 23, 2003 (JP) P. 2003-178088

(51) Int. Cl. G11B 5/66

(52) U.S. Cl. 428/694 BB; 428/694 R

(57) ABSTRACT

A magnetic recording medium comprising a magnetic layer, a flexible support and a back coat layer in this order, wherein a density of spines on the back coat layer having a height of 100 nm or more measured with an atomic force microscope is from 50 to 200 in 90 μm square, and a thermal shrinkage factor in a machine direction after preservation at 70° C. 5% RH for 48 hours is 0.4% or less.

### FIELD OF THE INVENTION

The present invention relates to a magnetic recording medium and magnetic recording and reproducing methods. In detail, the present invention relates to a magnetic recording medium excellent in electromagnetic characteristics, low in the deterioration of electromagnetic characteristics after storage and capable of high density recording, and also relates to magnetic recording and reproducing methods.

### BACKGROUND OF THE INVENTION

Magnetic recording media are widely used as the recording media of every data, e.g., voices, images and characters. In recent years, a requirement for high density recording is increasing with the improvements of the capacity of data to be recorded and transfer velocity, and magnetic recording media having high electromagnetic characteristics are demanded. Further, the reliability in using and storing data repeatedly is demanded at the same time. Accordingly, good running durability is also required of magnetic recording media in addition to excellent electromagnetic characteristics. Therefore, in particular in a tape medium, running ability is improved by providing a back coat layer. For improving running ability with a back coat layer, it has been conventionally tried to provide spines on the surface of a base, or to add carbon having a particle size of 0.2 μm or more to a back coat layer to roughen the surface of the back coat layer to thereby improve running durability (refer to, e.g., JP-A-9-91682 (the term “JP-A” as used herein refers to an “unexamined published Japanese patent application”) ). However, when the surface of a back coat layer is roughened by such a method, the back coat layer is pressed against a magnetic layer when a magnetic tape is wound up on a hub for preservation or processing and a phenomenon of so-called “offset” occurs, i.e., the ruggedness of the back coat layer is impressed upon the magnetic layer. As a result, electro-magnetic characteristics deteriorate. To solve this problem of “offset”, it is tried to smooth the surface of a back coat layer. However, when a back coat layer is smoothed, it becomes difficult for the air entrained by the winding up to come out, as a result, irregular winding such as the protrusion of the tape is liable to occur. Further, a friction coefficient becomes high, so that the running durability deteriorates. For solving this problem, a medium in which the density of spines on a backing layer having a specific height is restricted is proposed (refer to, e.g., JP-A-10-64041).

However, with the increase of recording density, the influence of the impression of the spines of a back coat layer upon a magnetic layer has become great. In particular, the influence is conspicuous in a linear recording system in which the pressure of contact of a head and the surface of a magnetic layer is low, and now it has come to the stage that recording failure, e.g., dropout, cannot be solved any longer by the conventional control of the density of spines alone.

In addition, in a magnetic recording medium having a thin magnetic layer for coping with high density recording, there are cases where spines bite a magnetic layer and the magnetic layer comes off. This problem is conspicuous when a tape is stored for a long period of time.

### SUMMARY OF THE INVENTION

Thus, a magnetic recording tape satisfying all of electromagnetic characteristics, running ability and storage stability for further increase of density has not got to be produced by the prior art. In particular, magnetic recording tapes for archives require thinning of the thickness of tapes at large nowadays, although magnetic tapes capable of retaining good electromagnetic characteristics for a long period of time are required, satisfactory magnetic recording tapes are not provided yet.

Accordingly, the present invention aims at solving the prior art problems and providing a magnetic recording medium for high density recording free from offset for a long period of time and excellent in electromagnetic characteristics and resistant to the deterioration of running durability after storage, and providing recording and reproducing methods.

As a result of eager investigation by the present inventors, it has been found that the drawbacks of the prior art can be solved by the following constitution, thereby a magnetic recording medium free from offset for a long period of time and excellent in electromagnetic characteristics and running durability after storage can be provided.

That is, the present invention is as follows.

(1) A magnetic recording medium comprising a flexible support having a magnetic layer on one side of the support and a back coat layer on the opposite side of the support, wherein the density of the spines (projections) on the back coat layer having a height of 100 nm or more measured with an atomic force microscope (AFM) is from 50 to 200 in 90 μm square, the thermal shrinkage factor in the machine direction after preservation at 70° C. 5% RH for 48 hours is 0.4% or less (in the invention, preferably 0.3% or less), and the magnetic recording medium is used in a recording and reproducing system having a reproducing track breadth of from 2 to 15 μm.

(2) The magnetic recording medium as described in the above item (1), wherein the reproducing track breadth is from 2 to 10 μm.

(3) The magnetic recording medium as described in the above item (1) or (2), wherein a nonmagnetic layer containing nonmagnetic powder and a binder is provided on the flexible support, and the magnetic layer having a thickness of from 30 to 150 nm is provided on the nonmagnetic layer.

(4) The magnetic recording medium as described in the above item (1), (2) or (3), wherein the coated layers including the magnetic layer provided on the side opposite to the side on which the back coat layer is provided have a glass transition point of from 100 to 200° C.

(5) The magnetic recording medium as described in the above item (1), wherein the flexible support is a polyester film having a Young's modulus in the machine direction of 5,880 MPa (600 kg/mm²) or more.

(6) Magnetic recording and reproducing methods of the magnetic recording medium as described in the above item (1) with a reproducing track breadth of from 2 to 15 μm.

The mechanisms of functions of the present invention are described below.

In the first place, by making the density of spines on a back coat layer from 50 to 200 in 90 μm square (preferably, from 50 to 150 in 90 μm square), running ability can be improved, winding can be bettered (by the exclusion of entrained air), and the phenomenon of offset can be reduced. By making the thermal shrinkage factor in the machine direction at 70° C. 5% RH 0.4% or less, over-fastening due to winding hardly occurs and the increase of offset can be prevented even after storage for a long period of time.

These effects are conspicuous in a magnetic layer having a thickness as thin as from 30 to 150 nm. The reason for this fact is that 50% or more of the height of the spines of a back coat layer having a height of 100 nm or more bite a magnetic layer in compliance with the condition, as a result 30% or more of the magnetic layer having the above thickness comes off, but when a magnetic layer is thicker, the ratio of coming off is small.

Further, by heightening the glass transition point of the coated layers including the magnetic layer, the influence of the impression of a back coat layer on a magnetic layer can be reduced. For lessening a thermal shrinkage factor, for example, as disclosed in JP-A-10-69628 and JP-A-11-96545, it is known to use a highly elastic film, e.g., aromatic polyamide and polybenzoxazole, as the support, but these films are expensive and weak in tearing strength. The objects of the invention can be achieved with conventional polyester films.

### DETAILED DESCRIPTION OF THE INVENTION

Magnetic recording media comprising a flexible support having a magnetic layer on one side of the support and a back coat layer on the opposite side are widely included in the magnetic recording medium according to the present invention. Accordingly, the magnetic recording medium in the invention includes magnetic recording media having layers other than a magnetic layer and a back coat layer. The magnetic recording medium in the invention may have, for instance, a nonmagnetic layer containing nonmagnetic powder, a soft magnetic layer containing soft magnetic powder, a second magnetic layer, a cushioning layer, an overcoat layer, an adhesive layer and a protective layer. These layers can be provided at appropriate positions so that they can effectively exhibit their functions. A magnetic recording medium having a nonmagnetic layer containing nonmagnetic inorganic powder and a binder between a flexible support and a magnetic layer is preferably used as the magnetic recording medium in the invention. The thickness of a magnetic layer is generally from 30 to 150 nm, preferably from 50 to 120 nm, and the thickness of a nonmagnetic layer is preferably from 0.5 to 3 μm, more preferably from 0.8 to 3 μm. It is preferred that the thickness of a nonmagnetic layer be thicker than the thickness of a magnetic layer. When a magnetic layer is provided alone, the thickness is generally from 0.1 to 5 μm, preferably from 0.1 to 3 μm, and more preferably from 0.1 to 1.5 μm. Although the total thickness of the magnetic recording medium in the invention is decided according to the use purpose, it is generally from 3 to 15 μm. With the increase of the capacity, the thickness of a magnetic recording medium is showing a tendency of thinning, and is from 3 to 9 μm in recent years.

Nonmagnetic powder dispersed in a binder is used in a back coat layer in the invention. As nonmagnetic powders, carbon blacks, metallic fine powders, organic fillers and metallic oxides are exemplified. Metallic oxides are preferred for chemical stability and excellent dispersibility, and carbon blacks are preferred for imparting electric conductivity, and it is more preferred to use them as mixture. As metallic oxides, titanium oxide, α-iron oxide, goethite, SiO₂, SnO₂, WO₃, Al₂O₃, ZrO₂ and ZnO are exemplified. In the case of granular particles, a particle size is preferably from 5 to 100 nm, more preferably from 10 to 70 nm. In the case of acicular particles, a long axis length is generally from 0.05 to 0.5 μm, preferably from 0.05 to 0.4 μm, and more preferably from 0.07 to 0.3 μm. In the case of tabular particles, the longest tabular diameter is generally from 0.05 to 2 μm, preferably from 0.05 to 1 μm.

Carbon blacks having an average primary particle size of generally 50 nm or less, preferably from 10 to 40 nm, can be used in a back coat layer for the purpose of imparting electric conductivity. When carbon black is used as mixture with metallic oxide, the ratio of metallic oxide/carbon black by weight is generally from 60/40 to 90/10, preferably from 70/30 to 90/10. When the particle size of carbon black is 50 nm or less, the structure grows and electric resistance preferably lowers. When the particle size is 10 nm or more, agglomeration of particles lessens and spines on a back coat surface are few, as a result offset reduces and so preferred.

Further, it is preferred to add carbon black having an average primary particle size of 50 nm or more as a solid lubricant to a back coat layer. The addition amount of the carbon black is from 0.1 to 10 parts per 100 parts of the sum total of metallic oxide and carbon black, preferably from 0.3 to 5 parts. When the addition amount is 10 parts or less, the number of spines on the surface of a back coat layer reduces and offset also reduces. Carbon blacks having a particle size of from 50 to 150 nm are particularly preferably used in the present invention.

Carbon blacks have pH of from 2 to 10, a water content of from 0.1 to 10%, and a tap density of from 0.1 to 1 g/ml. The specific surface area of carbon blacks having a particle size of 50 nm or less is preferably from 100 to 500 m²/g, more preferably from 150 to 400 m²/g, a DBP oil absorption amount of preferably from 20 to 400 ml/100 g, more preferably from 30 to 200 ml/100 g. The specific surface area of carbon blacks having a particle size of 80 nm or less is preferably from 5 to 100 m²/g, more preferably from 5 to 30 m²/g, a DBP oil absorption amount of preferably from 20 to 120 ml/100 g, more preferably from 30 to 110 ml/100 g.

As the binder for a back coat layer of the magnetic recording medium in the present invention, conventionally well-known thermoplastic resins, thermosetting resins and reactive resins can be used. The examples of preferred binders include cellulose resins not containing chlorine, e.g., nitrocellulose, phenoxy resins and polyurethane resins. Of these resins, polyurethane resins having a Tg of from 80 to 140° C. are more preferably used for improving storage property. Particularly preferred polyurethane resins are polyurethane resins obtained by the reaction of diol and organic diisocyanate, and the diol comprises from 17 to 40 wt % of short chain diol having a cyclic structure, and from 10 to 50 wt % of long chain diol having an ether bond respectively based on the polyurethane resin, and contains from 1.0 to 5.0 mol/g of the ether bond in the long chain diol based on the polyurethane resin.

The polyurethane resins preferably contain at least one polar group selected from the following groups in the molecule, e.g., —SO₃M, —OSO₃M, —COOM, —PO₃MM′, —OPO₃MM′, —NRR′ and —N+RR′ R′COO (wherein M and M′ each represents a hydrogen atom, an alkaline metal, an alkaline earth metal or an ammonium salt, R, R′ and R″ each represents an alkyl group having from 1 to 12 carbon atoms), and —SO₃M and —OSO₃M are particularly preferred. The amount of these polar groups is preferably from 1×10⁻⁵ to 2×10⁻⁴ eq/g, and particularly preferably from 5×10⁻⁵ to 1×10⁻⁴ eq/g. When the amount of polar groups is less than 1×10⁻⁵ eq/g, the adsorption of the binder onto the powder becomes insufficient, so that dispersibility lowers, while when the amount is more than 2×10⁻⁴ eq/g, the solubility in a solvent lowers, so that dispersibility lowers.

The polyurethane resins have number average molecular weight (Mn) of preferably from 5,000 to 100,000, more preferably from 10,000 to 50,000, and particularly preferably from 20,000 to 40,000. When the number average molecular weight of the polyurethane resins is 5,000 or more, film strength and durability increase. When it is 100,000 or less, the solubility in a solvent and dispersibility increase. The cyclic structure of the polyurethane resins contributes to stiffness and the ether group contributes to flexibility. The above polyurethane resins are high in solubility, great in radius of inertia (molecular spread), and good in the dispersibility of the powder. Further, the polyurethane resins possess two characteristics of stiffness of the resins themselves (high Tg and high Young's modulus) and tenacity (elongation).

A lubricant having a melting point of 80° C. or lower, preferably from −20 to 80° C., and more preferably from 0 to 65° C., is used in a back coat layer of the magnetic recording medium in the invention. For example, by adding a fatty acid to a back coat layer, rising of a friction coefficient during repeating running can be prevented. By the addition of a fatty acid ester, the scratch resistance can be improved at the time of high speed running. As the fatty acids, monobasic fatty acids having from 8 to 18 carbon atoms are exemplified. The specific examples of these fatty acids include a lauric acid, a caprylic acid, a myristic acids a palmitic acid, a stearic acid, an oleic acid, a linoleic acid, a linolenic acid and an elaidic acid. The addition amount of the fatty acids is from 0.1 to 5 weight parts, preferably from 0.1 to 3 weight parts, taking the total amount of the acicular nonmagnetic powder and the carbon black as 100 weight parts.

It is possible to increase the film strength of a back coat layer by improving dispersibility by the addition of aromatic organic compounds and titanium coupling agents for the purpose of preventing the increase of the friction coefficient. It is also possible to decrease the phenomenon of offset by suppressing the rising of the friction coefficient by adding organic powders. As the examples of fatty acids capable of being added, monobasic fatty acids having from 8 to 24 carbon atoms are exemplified. Monobasic fatty acids having from 8 to 18 carbon atoms are particularly preferred. The specific examples of these fatty acids include a lauric acid, a caprylic acid, a myristic acid, a palmitic acid, a stearic acid, a behenic acid, an oleic acid, a linoleic acid, a linolenic acid and an elaidic acid. The addition amount of the fatty acids is from 0.1 to 5 weight parts, preferably from 0.1 to 3 weight parts, taking the total amount of the granular oxide and the carbon black as 100 weight parts. The examples of fatty acid esters include fatty acid monoesters, fatty acid diesters and fatty acid triesters comprising a monobasic fatty acid having from 10 to 24 carbon atoms (which may contain an unsaturated bond or may be branched) and any one of mono-, di-, tri-, tetra-, penta- and hexa-alcohols having from 2 to 12 carbon atoms (which may contain an unsaturated bond or may be branched). The specific examples of these fatty acid esters include butyl stearate, octyl stearate, amyl stearate, isooctyl stearate, octyl myristate, butoxyethyl stearate, anhydrosorbitan monostearate, anhydrosorbitan distearate and anhydrosorbitan tristearate. The addition amount of the fatty acid esters is from 0.1 to 5 weight parts, preferably from 0.1 to 3 weight parts, taking the total amount of the granular oxide and the carbon black as 100 weight parts.

Further, it is preferred for a back coat layer of the magnetic recording medium in the invention to contain abrasive particles having a Mohs' hardness of 9 or more and an average primary particle size of from 10 to 40% of the thickness of the back coat layer for capable of further improving running durability. As the abrasive particles, α-alumina, chromium oxide, artificial diamond, and carbonic boron nitride (CBN) can be exemplified. Above all, it is preferred to use abrasive particles having an average particle size of 0.3 μm or less and a particle size of from 10 to 40% of the back coat layer thickness. When the particle size is 10% or smaller, the abrasive particles are buried in the back coat layer and cannot function as abrasive, while when the particle size exceeds 40%, spines increase and offset deteriorates.

The glass transition temperature of a back coat layer is from 80 to 180° C., preferably from 90 to 160° C.

Ferromagnetic powders for use in a magnetic layer of the magnetic recording medium in the invention are ferromagnetic iron oxides, cobalt-containing ferromagnetic iron oxides, barium ferrite powders and ferromagnetic metal powders. These ferromagnetic powders have an S_{BET} (specific surface area measured by a BET method) of from 40 to 80 m²/g, preferably from 50 to 70 m²/g, a crystallite size of from 12 to 25 nm, preferably from 13 to 22 nm, and particularly preferably from 14 to 20 nm, a long axis length of from 0.05 to 0.25 μm, preferably from 0.07 to 0.2 μm, and particularly preferably from 0.08 to 0.15 μm, and pH of 7 or more. The examples of ferromagnetic metal powders include simple metal powders or alloys, Fe, Ni, Fe-Co, Fe-Ni, Co-Ni and Co-Ni-Fe, and the ferromagnetic metal powders can contain the following metals in the proportion of 20 wt % or less of the metal components: aluminum, silicon, sulfur, scandium, titanium, vanadium, chromium, manganese, copper, zinc, yttrium, molybdenum, rhodium, palladium, gold, tin, antimony, boron, barium, tantalum, tungsten, rhenium, silver, lead, phosphorus, lanthanum, cerium, praseodymium, neodymium, tellurium and bismuth. Further, the ferromagnetic metal powders may contain a small amount of water, a hydroxide or an oxide. The producing methods of these ferromagnetic powders are well known, and the ferromagnetic powders for use in the invention can also be manufactured according to well-known methods. The forms of the ferromagnetic powders are not particularly restricted, and any form such as acicular, granular, die-like, ellipsoidal and tabular forms can be used in the present invention. Acicular ferromagnetic powders are particularly preferably used. In the present invention, a magnetic layer-forming coating solution is produced by kneading and dispersing a binder, a hardening agent and ferromagnetic powder with a solvent generally used in preparing a magnetic coating solution, e.g., methyl ethyl ketone, dioxane, cyclohexanone or ethyl acetate. Kneading and dispersing can be performed according to ordinary methods. A magnetic layer-forming coating solution may contain, besides the above components, generally used additives and fillers such as abrasives, e.g., α-Al₂O₃ or Cr₂O₃, antistatic agents, e.g., carbon black, lubricants, e.g., fatty acid, fatty acid ester and silicone oil, and dispersants.

In the next place, a lower nonmagnetic layer used when the invention takes a multilayer constitution is described below.

Inorganic powders for use in a lower layer in the invention may be magnetic powders or nonmagnetic powders. For example, the nonmagnetic powders can be selected from inorganic compounds, e.g., metallic oxides, metallic carbonates, metallic sulfates, metallic nitrides, metallic carbides and metallic sulfides, and nonmagnetic metals. The examples of the inorganic compounds are selected from the following compounds and they can be used alone or in combination, e.g., titanium oxides (TiO₂, TiO), α-alumina having an α-conversion rate of from 90 to 100%, β-alumina, γ-alumina, α-iron oxide, chromium oxide, zinc oxide, tin oxide, tungsten oxide, vanadium oxide, silicon carbide, cerium oxide, corundum, silicon nitride, titanium carbide, silicon dioxide, magnesium oxide, zirconium oxide, boron nitride, calcium carbonate, calcium sulfate, barium sulfate, molybdenum disulfide, goethite, and aluminum hydroxide. Titanium dioxide, zinc oxide, iron oxide and barium sulfate are particularly preferred, and titanium dioxides disclosed in JP-A-5-182177, and α-iron oxides disclosed in JP-A-6-60362 and JP-A-9-170003 are further preferred. As the nonmagnetic metals, Cu, Ti, Zn and Al are exemplified. These nonmagnetic powders preferably have an average particle size of from 0.005 to 2 μm, but if necessary, nonmagnetic powders each having a different average particle size may be combined, or single nonmagnetic powder having broad particle size variation may be used so as to obtain the same effect as such a combination. Particularly preferred nonmagnetic powders are those having an average particle size of from 0.01 to 0.2 μm. These nonmagnetic powders have a pH value of from 6 to 9, a specific surface area of from 1 to 100 m²/g, preferably from 5 to 50 m²/g, and more preferably from 7 to 40 m²/g, a crystallite size of from 0.01 to 2 μm, an oil absorption amount using DBP of from 5 to 100 ml/100 g, preferably from 10 to 80 ml/100 g, and more preferably from 20 to 60 ml/100 g, and a specific gravity of from 1 to 12, and preferably from 3 to 6. The form of the nonmagnetic powders may be any of acicular, spherical, polyhedral and tabular forms.

By incorporating carbon blacks into a lower layer, surface electrical resistance (Rs) can be reduced and a desired micro Vickers hardness can be obtained. The average particle size of carbon blacks is generally from 5 to 80 nm, preferably from 10 to 50 nm, and more preferably from 10 to 40 nm. Specifically, the carbon blacks which can be used in the above described back coat layer can be used in a lower layer.

In the magnetic recording medium in present invention, Tg of the layers coated on the side opposite to the side on which a back coat layer is coated is preferably from 100 to 200° C. Tg can be controlled by a heat treatment method of using a large amount of thermosetting crosslinking agent, e.g., polyisocyanate, and a method of using a binder having a high Tg, but a reaction occurs in crosslinking agent when a large amount of crosslinking agent is used, and the formed film becomes hard but brittle, thus not preferred in the point of durability. It is preferred in the present invention to use polyurethane having Tg of from 100 to 200° C. as disclosed in JP-A-2001-134921. The molecular weight of the polyurethane is from 10,000 to 100,000, preferably from 30,000 to 60,000. It is preferred for the polyurethane to contain a polar group, e.g., SO₃M or COOM, as the functional group.

As the flexible supports that can be used in the present invention, biaxially stretched polyethylene naphthalate (PEN), polyethylene terephthalate (PET), polyamide, polyimide, polyamideimide, aromatic polyamide and polybenzoxazole are exemplified. Polyester films excellent in general purpose use and inexpensive are very preferably used in the invention. These nonmagnetic supports may be subjected to surface treatment in advance, e.g., corona discharge treatment, plasma treatment, adhesion assisting treatment and heat treatment. The flexible supports that can be used in the present invention have a center line average surface roughness of from 0.1 to 20 nm at a cut-off value of 0.25 mm, preferably from 1 to 10 nm, and preferably have excellent surface smoothness. It is also preferred that the nonmagnetic supports not only have a small center line average surface roughness but are free from coarse spines of 1 μm or greater. The thickness of the nonmagnetic support is from 4 to 15 μm, preferably from 4 to 9 μm. When the thickness of the nonmagnetic support is thinner, the ruggedness of a back coat layer is liable to be impressed on a magnetic layer by handling tension, which can be effectively prevented by providing the polyurethane resin described above as the outermost layer of a back coat layer. When the thickness of a support is 7 μm or less, it is preferred to use PEN.

The magnetic recording medium in the invention can be manufactured by, e.g., depositing or coating a coating solution on the surface of a nonmagnetic support under running so that the layer thickness after drying comes into the prescribed range. A plurality of magnetic or nonmagnetic coating solutions may be multilayer-coated sequentially or simultaneously. Air doctor coating, blade coating, rod coating, extrusion coating, air knife coating, squeeze coating, immersion coating, reverse roll coating, transfer roll coating, gravure coating, kiss coating, cast coating, spray coating and spin coating can be used for coating a magnetic coating solution. Regarding these methods, e.g., Saishin Coating Gijutsu (The Latest Coating Techniques), Sogo Gijutsu Center (May 31, 1983) can be referred to. When a magnetic recording tape (medium) having two or more layers on one side of a support is manufactured, e.g., the following methods can be used.

(1) A method of coating a lower layer in the first place by using any of gravure coating, roll coating, blade coating, and extrusion coating apparatus, which are ordinarily used in the coating of a magnetic coating solution, and then coating an upper layer while the lower layer is still wet by means of a support-pressing type extrusion coating apparatus as disclosed in JP-B-1-46186 (the term “JP-B” as used herein means an “examined Japanese patent publication”), JP-A-60-238179 and JP-A-2-265672.

(2) A method of coating an upper layer and a lower layer almost simultaneously by using a coating head equipped with two slits for feeding coating solutions as disclosed in JP-A-63-88080, JP-A-2-17971 and JP-A-2-265672.

(3) A method of coating an upper layer and a lower layer almost simultaneously by using an extrusion coating apparatus equipped with a backup roll as disclosed in JP-A-2-174965.

A coated magnetic layer is dried after the ferromagnetic powder contained in the magnetic layer has been subjected to magnetic field orientation treatment. The magnetic field orientation treatment can be performed at one's discretion by well-known methods. After drying, the magnetic layer is subjected to surface smoothing treatment by, e.g., super calender rollers. The holes generated by the removal of the solvent by drying disappear by the surface smoothing treatment and the packing density of the ferromagnetic powder in the magnetic layer increases. As a result, a magnetic recording medium having high electromagnetic characteristics can be obtained. As the rollers for calendering treatment, heat resistive plastic rollers, e.g., epoxy, polyimide, polyamide and polyamideimide are used. Metal rollers may also be used for the treatment.

It is preferred for the magnetic recording medium in the invention to have a smooth surface. For obtaining a smooth surface, it is effective that a magnetic layer formed by selecting the foregoing specific binder is subjected to the calendering treatment. The calendering treatment is carried out at the temperature of calender rollers of from 60 to 100° C., preferably from 70 to 100° C., and particularly preferably from 80 to 100° C., and at the pressure of from 100 to 500 kg/cm, preferably from 200 to 450 kg/cm, and particularly preferably from 300 to 400 kg/cm. The thus-obtained magnetic recording medium is cut to a desired size with a cutter and the like before use. A magnetic recording medium having been subjected to calendering treatment is generally heat-treated to thereby reduce the thermal shrinkage factor, but at this time an impression of ruggedness of spines of a back coat layer becomes a problem. By making the Tg of coated layers including a magnetic layer from 100 to 200° C. as proposed in the invention, an impression occurring by heat treatment can be reduced. As other means of reducing a thermal shrinkage factor, a method of performing heat treatment of a magnetic recording medium in the form of a web by handling at low tension, and a method of performing heat treatment in the form of lamination of a tape as in the case of being built in a cassette can be used.

### EXAMPLES

The present invention will be described in further detail with reference to examples. The component, ratio, procedure and the like described in the following examples can be arbitrarily modified without departing from the spirit of the present invention. Accordingly, the scope of the invention is not limited by the specific examples shown in the following examples.

### Examples 1 to 5 and Comparative Examples 1 to 3

Production of Magnetic Recording Tape:

Magnetic recording tapes each different in a support and a back coat layer were manufactured by the method shown below.

Components a of the composition for forming a magnetic layer coating solution shown in the following Table 1 were kneaded by an open kneader, and then dispersed in a sand mill. Component b was added to the dispersion obtained, further component c was added, and the dispersion was filtered through a filter having an average pore diameter of 1 μm, thereby a magnetic layer-forming coating solution was prepared.

TABLE 1
Composition of magnetic layer-forming coating solution

| | | Weight |
|---|---|---|
| | Components | Parts |
| a | Ferromagnetic metal powder (Note 1) | 100 |
| a | Polyurethane resin A (note 2) | 18 |
| a | Phenylphosphonic acid | 5 |
| a | α-Al₂O₃ (average particle size: 0.15 μm) | 10 |
| a | Carbon black (average particle size: 80 nm) | 0.5 |
| a | Butyl stearate | 1 |
| a | Stearic acid | 1 |
| a | MEK | 120 |
| a | Cyclohexanone | 60 |
| b | Polyisocyanate (Coronate L) | 5 |
| c | MEK/cyclohexanone (1/1 mixed solvent) | 40 |

Note 1) Fe/Co (100/30 in atomic ratio), Fe/Al (100/11 in atomic ratio), Coercive force (Hc): 192 kA/m (2,430 Oe), crystallize size: 110 Π, saturation magnetization moment (σs): 110 Am²/kg, average long axis length: 0.045 μm, acicular ratio: 5.5 Note 2) Number average molecular weight: 42,000, Tg: 157° C., —SO₃Na group: 6 μeq/g (polyurethane resin A disclosed in JP-A-2001-134921)

| Synthetic composition | mol |
|---|---|
| Dimer diol | 0.074 |
| Compound A shown below | 0.015 |
| HPBA | 0.412 |
| MDI | 0.493 |

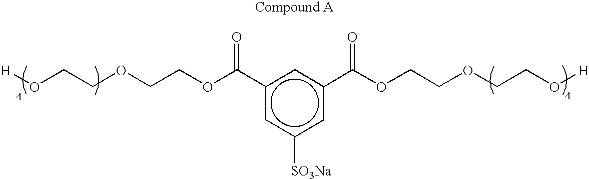

Components d of the composition for forming a nonmagnetic layer coating solution shown in the following Table 2 were kneaded by an open kneader, and then dispersed in a sand mill. Component e was added to the dispersion obtained, further component f was added, and the dispersion was filtered through a filter having an average pore diameter of 1 μm, thereby a nonmagnetic layer-forming coating solution was prepared.

TABLE 2
Composition of nonmagnetic layer-forming coating solution

| | | Weight |
|---|---|---|
| | Components | Parts |
| d | Acicular hematite (Note 3) | 80 |
| d | Polyurethane resin A (note 2) | 20 |
| d | Phenylphosphonic acid | 5 |
| d | α-Al₂O₃ (average particle size: 0.15 μm) | 10 |
| d | Carbon black (average particle size: 16 nm) | 20 |
| | (Note 4) | |
| d | Butyl stearate | 1 |
| d | Stearic acid | 1 |
| d | MEK | 120 |
| d | Cyclohexanone | 80 |
| e | Polyisocyanate (Coronate L) | 5 |
| f | MEK/cyclohexanone (1/1 mixed solvent) | 40 |

Note 3)
Average long axis length: 0.15 μm, acicular ratio: 8, S_{BET}: 58 m²/g, Surface-covering compound: Al₂O₃/SiO₂
Note 4)
DBPA: 120 ml/100 g, pH: 8, S_{BET}: 250 m²/g

Components g of the composition for forming a back coat layer coating solution A shown in the following Table 3 were kneaded, and then dispersed in a sand mill. Component h was added to the dispersion obtained, and the dispersion was filtered through a filter having an average pore diameter of 1 μm, thereby a back coat layer-forming coating solution in Example 1 of the invention was prepared.

TABLE 3
Back coat layer-forming coating solution A

| | | Weight |
|---|---|---|
| | Components | Parts |
| g | Carbon (1) (average particle size: 17 nm) | 100 |
| g | Carbon (2) (average particle size: 100 nm) | 16 |
| g | α-Al₂O₃ (average particle size: 0.18 μm) | 2 |
| g | Nitrocellulose resin | 130 |
| g | Polyurethane resin | 15 |
| h | Polyisocyanate | 40 |
| g | MEK | 2,000 |
| g | Toluene | 600 |

On a polyethylene naphthalate support (Ra on the magnetic layer side: 1.4 nm, Ra on the back coat layer side: 3 nm) having a thickness of 5.2 μm, the nonmagnetic layer-forming coating solution prepared above was coated in a dry thickness of 1.5 μm, and immediately after that the magnetic layer-forming coating solution was coated in a dry thickness of 0.07 μm. While the magnetic layer-forming coating solution was still wet, the magnetic layer was subjected to magnetic field orientation with a magnet of 0.3 T (3,000 Gauss) and dried. The back coat layer-forming coating solution was coated thereon in a dry thickness of 0.5 μm and dried. After drying, the magnetic layer was subjected to calendering treatment with a calender of seven stages of metal rollers by passing the medium roll between the nips of the metal rollers six times (velocity: 100 m/min, linear pressure: 300 kg/cm, temperature: 90° C.). The medium roll underwent annealing treatment at 70° C. for 24 hours after the calendering treatment, and slit into a strip 1/2 inches wide.

Tests and Measuring Methods:

The following tests and measurements were performed with each of the manufactured magnetic recording tapes.

(1) Measurements of SNR and Error Rate

SNRsk and error rate of each tape were measured with LTO-2 drive according to ECMA standard. The error rate of each tape after storage at 50° C. 80% RH for one month was also measured. As the reproducing head, a head different in the breadth of MR element was used. The target of SNRsk was 5 dB or more, and the upper limit of error rate was 10^{-5.}

(2) Density of Spines of Back Coat Layer

The number of spines having a height of 100 nm or higher in 90 μm square of the back coat layer was measured with an SiN probe of a quadrangular pyramid of a sharpness of 70′by Nanoscope 3 manufactured by Digital Instruments Corp.

(3) Thermal Shrinkage Factor

A sample tape of 10 cm in length was stored in a thermostatic tank at 70° C. 5% RH for 48 hours without applying tension. The lengths of the tape before and after storage were measured and the shrinkage factor was computed from the lengths.

(4) Tg of Coated Layers

The temperature dependency of dynamic viscoelasticity of all the layers of each sample was measured with Rheovibron (a product of Toyo Baldwin) at frequency of 110 Hz and temperature up velocity of 3° C./min. That of a sample from which coated layers were peeled off was measured in the same manner, and the temperature dependency of dynamic viscoelasticity of the layers E″ (loss elastic modulus) was obtained by subtracting the latter value from the former value. The peak of the temperature dependency curve of E″ was taken as Tg.

(5) Friction Coefficient of Back Coat Layer

A tape lapped over a pole of SUS420J (Ra 10 nm and 4 mm φ) at an angle of 180° was slid with load T1 of 100 g and a velocity of 42 mm/sec. Tensile force T2 of the tape at this time was measured and dynamic friction coefficient was obtained by the following Euler's equation. The target of the friction coefficient was 0.3 or less.

μ=(1/π)1n(T2/T1)

Results:

The results of the tests and measurements are shown in Table 4 below.

TABLE 4

| | | | | | | Comp. | Comp. | Comp. |
|---|---|---|---|---|---|---|---|---|
| | Ex. 1 | Ex. 2 | Ex. 3 | Ex. 4 | Ex. 5 | Ex. 1 | Ex. 2 | Ex. 3 |
| Reproducing track breadth (μm) | 7.5 | 7.5 | 7.5 | 10 | 3 | 7.5 | 3 | 17 |
| Tg of urethane in back coat layer (° C.) | 157 | 157 | 157 | 115 | 185 | 75 | 210 | 157 |
| Particle size of carbon (2) in back coat | 100 | 100 | 150 | 150 | 100 | 270 | 30 | 100 |
| layer (nm) | | | | | | | | |
| Addition amount of carbon (2) in back | 16 | 8 | 16 | 16 | 8 | 25 | 8 | 16 |
| coat layer (parts) | | | | | | | | |
| Young's modulus of support (kg/mm²) | 700 | 700 | 700 | 900 | 900 | 700 | 700 | 450 |
| Annealing (° C./hr) | 70/24 | 50/12 | 70/24 | None | None | None | 70/24 | None |
| Density of spines in back coat layer | 90 | 55 | 190 | 190 | 58 | 280 | 32 | 110 |
| (number/90 μm square) | | | | | | | | |
| Thermal shrinkage factor (70° C. 5% | 0.16 | 0.35 | 0.2 | 0.32 | 0.25 | 0.43 | 0.13 | 0.5 |
| RH, 48 hours) (%) | | | | | | | | |
| Magnetic layer thickness (nm) | 100 | 100 | 100 | 40 | 135 | 200 | 100 | 100 |
| Tg of coated layers (° C.) | 140 | 140 | 140 | 105 | 185 | 72 | 205 | 140 |
| SNRsk | 5.7 | 6.5 | 5.1 | 6.7 | 5.1 | 2.1 | 1.6 | 4.9 |
| Initial error rate (×10⁻⁷) | 6.2 | 3.1 | 7.1 | 3 | 9.5 | 80 | 85 | 7 |
| Error rate after storage (×10⁻⁷) | 50 | 62 | 87 | 110 | 24 | 12,000 | 160 | 8,000 |
| Friction coefficient of back coat layer | 0.23 | 0.26 | 0.21 | 0.22 | 0.27 | 0.21 | 0.41 | 0.26 |

As described above, in the magnetic recording medium according to the invention, by making the density of spines on a back coat layer having a height of 100 nm or higher measured with an atomic force microscope (AFM) from 50 to 200 in 90 μm square, and by making the thermal shrinkage factor in the machine direction after preservation at 70° C. 5% RH for 48 hours 0.4% or less, over-fastening due to winding hardly occurs and the increase of offset can be prevented even after preservation for a long period of time, and even when a reproducing track having a breadth of from 2 to 15 μm is used, electromagnetic characteristics and running durability can be improved without causing recording failure, e.g., dropout.

This application is based on Japanese Patent application JP 2003-178088, filed June 23, 2003, the entire content of which is hereby incorporated by reference, the same as if set forth at length.

What is claimed is:

1. A magnetic recording medium comprising a magnetic layer, a flexible support and a back coat layer in this order, wherein a density of spines on the back coat layer having a height of 100 nm or more measured with an atomic force microscope is from 50 to 200 in 90 μm square, and a thermal shrinkage factor in a machine direction after preservation at 70° C. 5% RH for 48 hours is 0.4% or less.

2. The magnetic recording medium according to claim 1, which is used in a recording and reproducing system having a reproducing track breadth of from 2 to 15 μm

3. The magnetic recording medium according to claim 1, which is used in a recording and reproducing system having a reproducing track breadth of from 2 to 10 μm

4. The magnetic recording medium according to claim 1, further comprising a nonmagnetic layer containing nonmagnetic powder and a binder so that the magnetic layer, the nonmagnetic layer and the flexible support are in this order, wherein the magnetic layer has a thickness of from 30 to 150 nm.

5. The magnetic recording medium according to claim 4, wherein the magnetic layer has a thickness of from 50 to 120 nm.

6. The magnetic recording medium according to claim 1, wherein coated layers including the magnetic layer provided on a side of the support opposite to a side of the support on which the back coat layer is provided have a glass transition point of from 100 to 200° C.

7. The magnetic recording medium according to claim 1, wherein the flexible support is a polyester film having a Young's modulus in a machine direction of 5,880 MPa or more.

8. The magnetic recording medium according to claim 1, wherein the back coat layer contains nonmagnetic powder and a binder.

9. The magnetic recording medium according to claim 8, wherein the nonmagnetic powder contains a carbon black.

10. The magnetic recording medium according to claim 9, wherein the carbon black has an average primary particle size of 50 nm or less.

11. The magnetic recording medium according to claim 9, wherein the carbon black has an average primary particle size of from 10 to 40 nm.

12. The magnetic recording medium according to claim 1, wherein the back coat layer has a glass transition temperature of from 80 to 180° C.

13. The magnetic recording medium according to claim 1, wherein the back coat layer has a glass transition temperature of from 90 to 160° C.

14. A method comprising recording and reproducing the magnetic recording medium according to claim 1 with a reproducing track breadth of from 2 to 15 μm.

15. The method according to claim 14, wherein the reproducing track breadth is from 2 to 10 μm.
